(19) United States
(12) Patent Application Publication
(10) Pub. No.: US 2003/0129564 A1
(43) Pub. Date: Jul. 10, 2003

(54) Implant for an artificial tooth having an impact decreasing device

(76) Inventor: Gyu Kang, Chungcheonbuk-Do (KR)

Correspondence Address: BURNS DOANE SWECKER & MATHIS L L P, POST OFFICE BOX 1404, ALEXANDRIA, VA, 22313-1404, US

(21) Appl. No.: 10/065,309

(22) Filed: Oct. 2, 2002

(30) Foreign Application Priority Data
Jan. 5, 2002 (WO) PCT/KR02/00008
Dec. 26, 2001 (KR) 2001-84986
Dec. 26, 2001 (KR) 2001-0040138

(51) Int. Cl. A61C 8/00

(52) U.S. Cl. 433/173

(57) ABSTRACT

The present invention relates to a fixture for artificial teeth having a buffer member. The fixture for artificial teeth comprises a body in which a screw is formed on the surface of the body, a plurality of fixing grooves are formed on the top of the body and an insertion groove is formed within the body; a buffer member inserted into the insertion groove formed within the body, wherein a part of the buffer member is protruded toward an upper side of the body; an anti-rotation member fixed into the insertion groove of the body, with the anti-rotation member inserted into the buffer member; a fixing member that is fixed to the body on the top of the buffer member into which the anti-rotation member is inserted in order to prevent deviation of the buffer member, wherein a through-groove corresponding to the fixing grooves of the body is formed on the top of the fixing member; a fixing pin penetrating the through-groove formed on the top of the fixing member and inserted into the fixing grooves formed on the top of the body, so that the fixing member is prevent to be deviated on the top of the body; and a support pole fixed to the anti-rotation member fixed within the insertion groove of the body with it inserted into the buffer member, wherein a part of the support pole is protruded toward an upper side to fix the artificial teeth.

### BACKGROUND OF INVENTION

1. Field of the Invention

The invention relates generally to a fixture for artificial teeth that is used the artificial teeth are implanted, and more particularly to, a fixture for artificial teeth having a buffer member that mitigates an occlusion pressure occurring when a food is chewed, thus preventing damage of the alveolar bone.

2. Description of the Prior Art

As shown in FIG. 1, the teeth fixed to an alveolar bone 100 include a periodontal ligament 300 that is formed between the alveolar bone 100 protected by a gingival 200 and natural teeth 400. Therefore, the upper teeth and the lower teeth are occluded while they are contacting when a food is chewed.

When the upper teeth and the lower teeth are occluded, the periodontal ligament 300 buffers the natural teeth 400 to which the periodontal ligament 300 is occluded. As the occlusion pressure transmitted to the alveolar bone 100 is uniformly distributed, damage of the alveolar bone 100 can be prevented.

If the natural teeth as above are carelessly managed, however, a food could not be chewed. Thus, artificial teeth are used instead of the natural teeth.

As known in a prior art, the artificial teeth fixed to the alveolar bone have a fixture for the artificial teeth fixed to the alveolar bone are fixed to the top of the fixture.

In a conventional fixture for the artificial teeth, the periodontal ligament is cut in order to fix a body of the fixture to the alveolar bone. A support pole in which the artificial teeth are formed is inserted into the body using a screw formed in the fixture, with the alveolar bone at a portion where the periodontal ligament is cut fixed.

As no additional means for buffering the occlusion pressure occurring when a food is chewed is not provided in the body of the fixture and the support pole as above, the occlusion pressure is transmitted to the alveolar bone through the artificial teeth. Therefore, if the artificial teeth are used for a long time, the alveolar bone is collapsed. Due to this, there are problems that the body of the fixture is extended and the height between the natural teeth and the artificial teeth are varied.

Further, in the natural teeth, the natural teeth are naturally buffered when a food is chewed since the fixture is fixed to the alveolar bone. On the other hand, in the artificial teeth, the artificial teeth are not buffered. A person feels a feeling of an alien substance. As the body fixed to the alveolar bone and the support pole fixed to the artificial teeth are fixed each other by a female screw and a male screw, the support pole to which the artificial teeth are fixed is rotated in the body. There is a problem that an arrangement of the artificial teeth and the natural teeth is varied.

### SUMMARY OF INVENTION

The present invention is contrived to solve the above problems and an object of the present invention is to provide a fixture for artificial teeth having a buffer member that mitigates an occlusion pressure occurring when a food is chewed to obviate a feeling of an alien substance without affecting an alveolar bone.

The buffer member that is inserted into a body fixed to the alveolar bone is provided on the top of the fixture to prevent a support pole to which the artificial teeth are fixed from rotating in the body.

In order to accomplish the above object, a fixture for artificial teeth having a buffer member according to the present invention, is characterized in that it comprises a body in which a screw is formed on the surface of the body, a plurality of fixing grooves are formed on the top of the body and an insertion groove is formed within the body; a buffer member inserted into the insertion groove formed within the body, wherein a part of the buffer member is protruded toward an upper side of the body; an anti-rotation member fixed into the insertion groove of the body, with the anti-rotation member inserted into the buffer member; a fixing member that is fixed to the body on the top of the buffer member into which the anti-rotation member is inserted in order to prevent deviation of the buffer member, wherein a through-groove corresponding to the fixing grooves of the body is formed on the top of the fixing member; a fixing pin penetrating the through-groove formed on the top of the fixing member and inserted into the fixing grooves formed on the top of the body, so that the fixing member is prevent to be deviated on the top of the body; and a support pole fixed to the anti-rotation member fixed within the insertion groove of the body with it inserted into the buffer Member, wherein a part of the support pole is protruded toward an upper side to fix the artificial teeth.

### BRIEF DESCRIPTION OF DRAWINGS

The aforementioned aspects and other features of the present invention will be explained in the following description, taken in conjunction with the accompanying drawings, wherein:

FIG. 1 is a cross-sectional view of the teeth for illustrating a state that the teeth are fixed;

FIG. 2 is a dismantled perspective view of a fixture for artificial teeth according to a preferred embodiment of the present invention; and

FIG. 3 is a cross-sectional view of the fixture for the artificial teeth for illustrating a state that the fixture is fixed to an alveolar bone according to the present invention.

### DETAILED DESCRIPTION

The present invention will be described in detail by way of a preferred embodiment with reference to accompanying drawings.

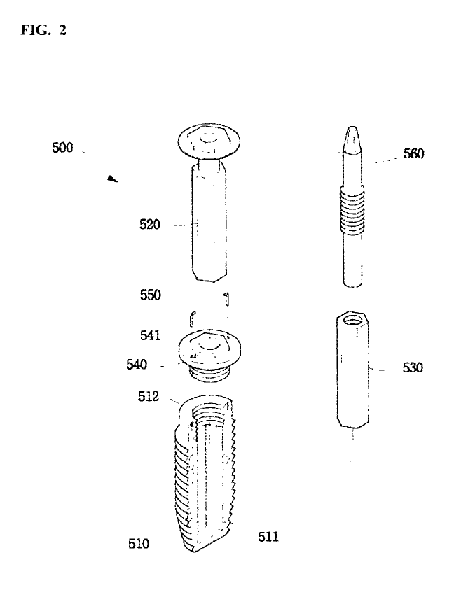

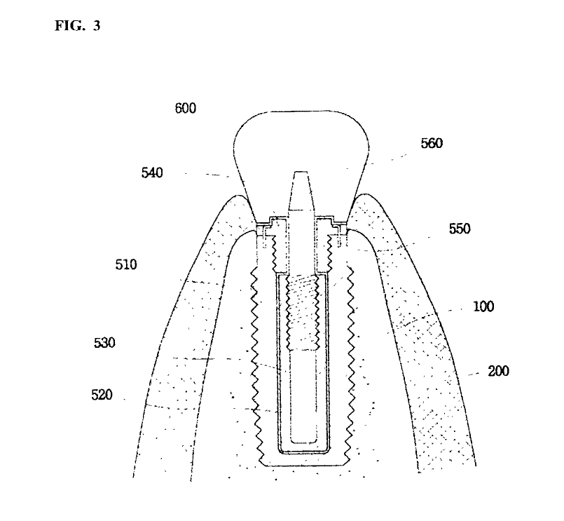

FIG. 2 is a dismantled perspective view of a fixture for artificial teeth according to a preferred embodiment of the present invention and FIG. 3 is a cross-sectional view of the fixture for the artificial teeth for illustrating a state that the fixture is fixed to an alveolar bone according to the present invention.

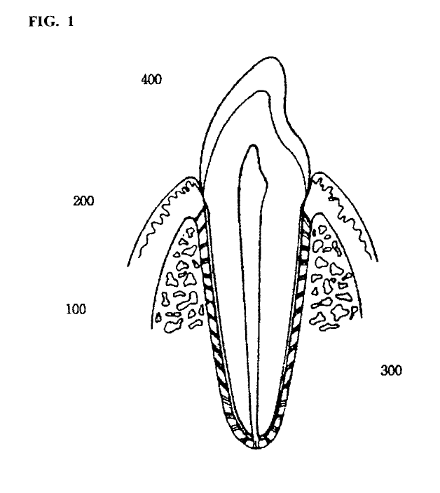

Referring now to FIG. 2 and FIG. 3, the fixture for the artificial teeth 500 is fixed to the alveolar bone 100 (see FIG. 1) that is protected by a gingival 200. A male screw is formed on the surface of a body 510 in the fixture for the artificial teeth 500.

A plurality of fixing grooves 512 are formed on an upper portion of the body 510 in the fixture for the artificial teeth 500.

A polygonal insertion groove 511 is formed within the body 510 in which the plurality of the fixing grooves 512 are formed, as shown in FIG. 2.

At this time, it is preferred that the polygonal insertion groove 511 formed within the body 510 has a hexagonal shape. However, it is should be noted that the shape of the polygonal insertion groove 511 may be rectangular, octagonal or more shape.

A buffer member 520 is inserted into the polygonal insertion groove 511 formed within the body 510. At this time, the buffer member 520 is made of a rubber or synthetic resins and has a high resilient force.

A lower portion of the buffer member 520 inserted into the insertion groove 511 of the body 510 is formed to have a polygonal shape corresponding to the shape of the insertion groove 511 of the body 510. An upper portion of the buffer member 520 is formed to have the same width to the body 510 of the fixture for the artificial teeth 500.

A polygonal anti-rotation member 530 corresponding to the insertion groove 511 formed within the body 510 is inserted into the buffer member 520 inserted into the insertion groove 511 formed within the body 510. It is thus possible to prevent the polygonal anti-rotation member 530 and the buffer member 520 from rotating within the body 510 when the anti-rotation member 530 is inserted into the insertion groove 511 of the body 510.

As above, a fixing member 540 is fixed on the top of the buffer member 520 that are inserted into the insertion groove 511 formed within the body 510 along with the anti-rotation member 530.

It is preferred that the fixing member 540 fixed to the buffer member 520 is fixed to the bottom of the lower portion formed to have the same width to the body 510. When the buffer member 520 to which the fixing member 540 is fixed is inserted into the insertion groove 511 of the body 510, the fixing member 540 is fixed to the top of the body 510.

A plurality of through-grooves 541 are formed on the top of the fixing member 540 fixed on the top of the body 510 at a location corresponding to the fixing grooves 512 formed on the top of the body 510.

In a state that the anti-rotation member 530 and the buffer member 520 are inserted into the insertion groove 511 of the body 510, when the fixing member 540 is fixed to the body 510 at the bottom of the upper side of the buffer member 520, the anti-rotation member 530 into which the fixing member 540 and the buffer member 520 are inserted into the insertion groove 511 of the body 510 is prevented from deviation toward an upper side.

It is preferred that the female screw and the male screw are fixed to the fixing member 540 fixed on the top of the body 510 and the body 510, when the anti-rotation member 530 and the buffer member 520 are inserted into the insertion groove 5110 together. The top of the fixing member 540 is covered by a portion formed to have the same width to the body 510, on the top of the buffer member 520 when the fixing member 540 is fixed to the top of the body 510.

In a state that the buffer member 510 into which the anti-rotation member 530 is inserted is inserted into the insertion groove 511 of the body 510, a fixing pin 550 is fixed in the fixing grooves 512 formed on the top of the body 510, at a location corresponding to the through-groove 541 formed on the top of the fixing member 540 fixed on the top of the body 510. The fixing pin 550 prevents the fixing member 510 fixed to the top of the body 510 from rotating and deviating within the body 510.

If the buffer member 520 into which the anti-rotation member 530 is inserted is fixed to the insertion groove 511 formed within the body 510 and the fixing member 540 is fixed to the top of the body 510, a support pole 560 to which the artificial teeth 600 are fixed is fixed to the anti-rotation member 530 that is inserted into the insertion groove 511 of the body 510 along with the buffer member 520.

It is preferred that a method of fixing the support pole 560 to the anti-rotation member 530 includes screwing the female screw at one side and screwing the male screw at the other side. At this time, a portion of the support pole 560 is protruded toward an upper side of the buffer member 520.

In the present invention constructed above, the artificial teeth 600 is first fixed to the alveolar bone 100 by means of the screw formed in the body 510 of the fixture for the artificial teeth 500, as shown in FIG. 3.

After a given time elapses with the body 510 of the fixture for the artificial teeth 500 fixed to the alveolar bone 100, the anti-rotation member 530 is inserted. The buffer member 520 on the top of which the fixing member 540 is formed is inserted into the insertion groove 511 formed within the body 510 of the fixture for the artificial teeth 500.

As such, as the anti-rotation member 530 and the buffer member 520 that are inserted into the insertion groove 511 of the body 510, and the insertion groove 511 have a polygonal shape corresponding one another, the anti-rotation member 530 and the buffer member 520 are not rotated with them inserted into the insertion groove 511 of the body 510.

After the buffer member 520 into which the anti-rotation member 530 is inserted is inserted into the insertion groove 511 of the body 510, the fixing member 540 is fixed to the top of the body 510. It is thus possible to prevent the anti-rotation member 530 inserted into the insertion groove 511 of the body 510 from deviating toward an upper side.

After the fixing member 540 is fixed to the top of the body 510, the fixing pin 550 is inserted into the plurality of the through-grooves 541 and the fixing grooves 512 which are formed corresponding to the top of the fixing member 540 and the body 510. It is thus possible to prevent the fixing member 540 from rotating/deviating in/from the body 510.

After the buffer member 520 into which the anti-rotating member 530 is inserted is inserted into the body 510 of the fixture for the artificial teeth 500 fixed to the alveolar bone 100 and the fixing member 540 is also fixed to the top of the body 510, the support pole 560 is fixed to the anti-rotation member 530 inserted into the insertion groove 511 formed within the body 510, as shown in FIG. 3.

The anti-rotation member 530 has the shape corresponding to the insertion groove 511 of the body 510 of a polygonal shape when the support pole 560 is fixed to the anti-rotation member 530. Thus, the anti-rotation member 530 does not rotate even if the support pole 560 is fixed.

When the anti-rotation member 530 inserted into the insertion groove 511 formed within the body 510 along with the buffer member 520 is fixed to the support pole 560, the support pole 560 is protruded longer than the end of the buffer member 520 covering the top of the fixing member 540.

As such, the artificial teeth 600 are fixed on the top of the buffer member 520 and the support pole 560 that is longer protruded than the buffer member 520 of the fixing member 540, using an adhesive, etc.

As such, as a part of the artificial teeth 600 along with the support pole 560 is fixed to the buffer member 520 and the support pole 560 to which the artificial teeth 600 are fixed is inserted into the anti-rotation member 530 formed within the buffer member 520, the occlusion pressure occurring when a food is chewed using the artificial teeth 600 is mitigated while it is transmitted to the buffer member 520, thus protecting the alveolar bone 100.

Further, as the insertion groove 511 formed within the body 510 and the anti-rotating member 530 inserted into the insertion groove 511 have a polygonal shape, the support pole 560 fixed to the anti-rotation member 530 is not rotated. It is thus possible to prevent an alignment of the artificial teeth 600 and the natural teeth 400 from dispersing.

As described above, according to the present invention, the buffer member is fixed between the body fixed to the alveolar bone and the support pole fixed to the body. With this structure, the occlusion pressure is not directly transferred to the alveolar bone and the occlusion pressure is thus mitigated, when a food is chewed. Therefore, the present invention has an advantage that it can prevent an erosion of the alveolar bone de to the occlusion pressure.

Further, as the artificial teeth are pushed and mitigated by the buffer member when a food is chewed, the artificial teeth serve as a periodontal ligament of the natural teeth. Therefore, the present invention obviates a feeling of an alien substance when a food is chewed.

In addition, the insertion groove of a polygonal shape is formed within the body fixed to the alveolar bone, and the anti-rotation member that is inserted into the insert groove of the body and fixes the support pole is formed to have a polygonal shape corresponding to the insertion groove. Due to this, the support pole fixed to the anti-rotation member is not rotated since the anti-rotation member is prevented from rotating within the body. Therefore, the present invention has an advantage that it can prevent an alignment of the teeth form dispersing.

The present invention has been described with reference to the fixture for artificial teeth having a buffer member in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

1. A fixture for artificial teeth having a buffer member, comprising:
a body in which a screw is formed on the surface of the body, a plurality of fixing grooves are formed on the top of the body and an insertion groove is formed within the body;
a buffer member inserted into the insertion groove formed within the body, wherein a part of the buffer member is protruded toward an upper side of the body;
an anti-rotation member fixed into the insertion groove of the body, with the anti-rotation member inserted into the buffer member;
a fixing member that is fixed to the body on the top of the buffer member into which the anti-rotation member is inserted in order to prevent deviation of the buffer member, wherein a through-groove corresponding to the fixing grooves of the body is formed on the top of the fixing member;
a fixing pin penetrating the through-groove formed on the top of the fixing member and inserted into the fixing grooves formed on the top of the body, so that the fixing member is prevent to be deviated on the top of the body; and
a support pole fixed to the anti-rotation member fixed within the insertion groove of the body with it inserted into the buffer member, wherein a part of the support pole is protruded toward an upper side to fix the artificial teeth.

2. The fixture for artificial teeth as claimed in claim 1, wherein the insertion groove formed within the body is formed to have a polygonal shape, and the buffer member and the anti-rotation member both of which are inserted into the insertion groove of the body are formed to have a polygonal shape corresponding to the insertion groove of the body, so that the buffer member and the anti-rotation member are not rotated with them inserted into the insertion groove of the body.
